(19) United States
(12) Patent Application Publication
(10) Pub. No.: US 2009/0095787 A1
(43) Pub. Date: Apr. 16, 2009

(54) Transmission Mechanism for Electric Nail Gun

(76) Inventors: Chia-Sheng Liang, Bali Shiang (TW); Chin-Lung Chang, Bali Shiang (TW); Chu Hsiang Tseng, Bali Shiang (TW)

Correspondence Address: HDLS Patent & Trademark Services, P.O. BOX 220746, CHANTILLY, VA, 20153-0746, US

(21) Appl. No.: 11/871,192

(22) Filed: Oct. 12, 2007

(51) Int. Cl. B25C 1/06

(52) U.S. Cl. 227/131

(57) ABSTRACT

A transmission mechanism for an electric nail gun includes a linear transmission unit and a rotary transmission unit in a housing of the electric nail gun. The rotary transmission unit includes an electric driven driving wheel. The linear transmission unit includes a rack and a hitting bar. The hitting bar is disposed at a bottom of the linear transmission unit. The rack is in mesh with the driving wheel, slidably installed in the housing by a spring force, and configured to receive driving from the driving wheel and to drive the hitting bar to move linearly downward so as to hit a nail.

### BACKGROUND OF THE INVENTION

1. Field of the Invention

The present invention relates to a transmission mechanism for an electric nail gun, and more particularly to a transmission mechanism with a driving wheel driven by electricity disposed in a nail gun housing and a rack disposed in the nail gun housing and in mesh with the driving wheel, the driving wheel being configure for driving the rack to move downward linearly to hit a nail.

2. Description of Related Art

An electric nail gun is a type of tool used to drive nails into wood or some other kind of material. Usually, there is a battery pack or an AC electrical power source in a housing of the electric nail gun to provide electrical power to a motor, thereby rotating the motor. A rotary kinetic energy of the motor is transformed into a linear kinetic energy by a transmission mechanism to drive a hitting bar to hit a nail.

Among a more advanced technology, many US patents, such as U.S. Pat. No. 6,607,111 and U.S. Pat. No. 6,669,072 and so on, teach a flywheel driven by a DC motor, a clutch assembly being capable of moving linearly by traction of a wire disposed on an axis of a solenoid. The clutch assembly has a wire drum and connects to a driving stand of a nail hitting bar by at least a wire. When a nail gun is driven by a user, the clutch assembly is moved along an axis direction to mesh with a flywheel which is rotating, thereby rotating the clutch assembly. Therefore, a rotary kinetic energy is transformed into a linear kinetic energy of the hitting bar to then hit nails via traction of the wire. However, the structure of the clutch assembly is complicated with too many components. In addition, using a wire to pull the driving stand and the hitting bar may cause high temperature and wearing on the wire so that the durability and the lifetime of the wire are reduced. Hence, the above mentioned driving mechanism needs to be improved.

### SUMMARY OF THE INVENTION

What is needed, therefore, is to provide a transmission mechanism for an electric nail gun, which uses a flywheel to rotate a driving wheel so as to drive a rack to further drive a hitting bar to move linearly downward and hit a nail, so as to simplify a wire drum and a clutch assembly and overcome the problem of reduced lifetime of a wire in a previous technology.

To achieve the above objective, preferred embodiments of the present invention provide a transmission mechanism for an electric nail gun including a linear transmission unit in a housing of the electric nail gun and a rotary transmission unit in the housing. The rotary transmission unit includes an electric driven driving wheel. The linear transmission unit includes a rack in mesh with the driving wheel and slidably installed in the housing by a spring force, and a hitting bar at a bottom of the linear transmission unit. The rack is configured to receive driving from the driving wheel and to drive the hitting bar to move linearly downward to hit a nail.

In addition, at least a guiding bar is vertically disposed on a side of the driving wheel, the rack is slidably installed on the guiding bar, and a first elastic member is disposed on the guiding bar and configured for pushing the rack to drive the hitting bar to move upward and reset when the driving wheel stops rotating. A slide base is disposed on a top of the rack holding the guiding bars and configured for guiding the rack to be slidably installed on the guiding bars. At least a turning wheel is pivotably disposed near to the driving wheel. The rack is disposed between the driving wheel and the turning wheel and in mesh with the driving wheel.

The rotary transmission unit of the present invention further includes a motor, a flywheel, and a solenoid. The motor is driven by electricity. The flywheel is driven by the motor and pivotably mounted on a stop shaft. The flywheel has a cylinder extending from a side of the flywheel. The cylinder is made of magnetic material and defines a ring-shaped receiving chamber therein. The solenoid can be activated by electricity and is buried in the receiving chamber, being configured for forming magnetic field around a magnetic loop on the cylinder. The driving wheel is movably and pivotably disposed between an engagement position near to an end of the cylinder and a disengagement position. At least two friction surfaces are respectively disposed near to the driving wheel and the cylinder therebetween. The friction surfaces are capable of working as a clutch.

By this means, when the solenoid is activated by electricity, the driving wheel is attracted to move to the engagement position to be driven by the flywheel, and thereby drives the linear transmission unit to hit a nail. When the solenoid is demagnetized the driving wheel is configured to be released and reset to the disengagement position to disengage from the flywheel, and thereby to stop driving the linear transmission unit.

In further embodiments, the rotary transmission unit further includes a second elastic member configured for exerting an pushing force on the driving wheel, and thereby pushing the driving wheel from the engagement position to the disengagement position. The pushing force is configured less than the force exerted by the magnetic field to attract the driving wheel to move. The second elastic member is disposed between a ring-shaped bearing securely mounted on a stop shaft and a ring-shaped traction stand moveably and pivotably attached to the stop shaft.

In yet further embodiments, the rotary transmission unit includes a second elastic member configured for exerting an pushing force on the driving wheel, thereby pushing the driving wheel from the engagement position to the disengagement position. The pushing force being configured less than the force with which the traction stand attracted by the magnetic field drives a push paw to push the driving wheel to move. The second elastic member is disposed in the cylinder between the flywheel and the driving wheel.

It is a novelty for employing magnetic field effect of the solenoid to control engagement or disengagement of the driving wheel in/from the flywheel so as to transmit rotary kinetic energy to drive the rack to move the hitting bar downward to hit a nail. The configuration space of the components is sufficiently saved. In addition, because two frictional surfaces are formed between the driving wheel and the cylinder which can be used as a clutch, the rotary kinetic energy of the flywheel is fully transmitted to the driving wheel. Furthermore, the rack is used as a following device in the linear transmission unit so that even when temperature is raised high after long time of operation, the wearing between the driving wheel and the rack can still be reduced. It also facilitates transformation of the rotary kinetic energy of the driving wheel into the linear kinetic energy of the rack, thereby improving the durability of the transmission mechanism for the electric nail gun in a space-saving fashion.

Other advantages and novel features will be drawn from the following detailed description of preferred embodiment with the attached drawings, in which:

### BRIEF DESCRIPTION OF THE DRAWINGS

FIG. 1 is a perspective view of a transmission mechanism for an electric nail gun in accordance with a first preferred embodiment of the present invention;

FIG. 2 is a cutaway view of a transmission mechanism for an electric nail gun in accordance with the first preferred embodiment of the present invention;

FIG. 3 is a cross-sectional view of FIG. 2, taken along the line 3-3;

FIG. 4 is a cross-sectional view of FIG. 2, taken along the line 4-4;

FIG. 5a to FIG. 5c is a schematic view of the first preferred embodiment of the present invention, starting an operation mode in the working status;

FIG. 6a to FIG. 6e is a working schematic view of the first preferred embodiment of the present invention, starting another operation mode;

FIG. 7 is a cutaway view of a transmission mechanism for an electric nail gun in accordance with a second preferred embodiment of the present invention;

FIG. 7a and FIG. 7b are schematic views of FIG. 7 in the working status.

### DETAILED DESCRIPTION OF THE INVENTION

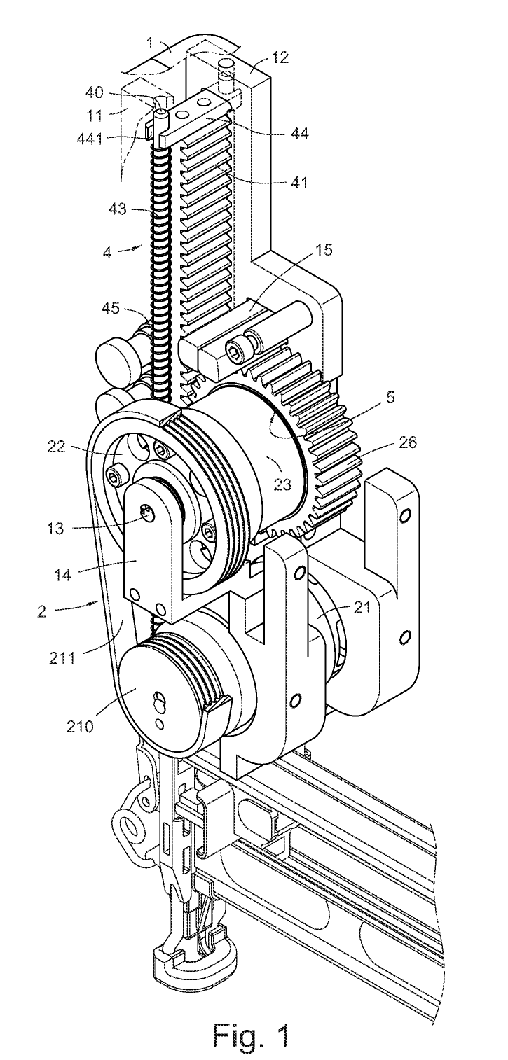

Referring to FIG. 1, a transmission mechanism for an electric nail gun in accordance with a first embodiment of the present invention is provided. A suitable power source, such as the battery pack 10 for providing direct current to the transmission mechanism, is received in a distal end of a housing 1. Two opposing supporting bracket 11, 12 are formed on a head portion of the housing 1 to mount a rotary transmission unit 2 and a linear transmission unit 4 thereon. A first switch 16 and a second switch 17 are formed on the housing 1. The first switch 16 is disposed on a bottom end of the housing 1 touchable by a safe sliding rod 18. The second switch 17 is located on an end side of the housing 1 touchable by a trigger 19 mounted on an end of the housing 1. The rotary transmission unit 2 has an electric driven driving wheel 26, preferably a driving gear.

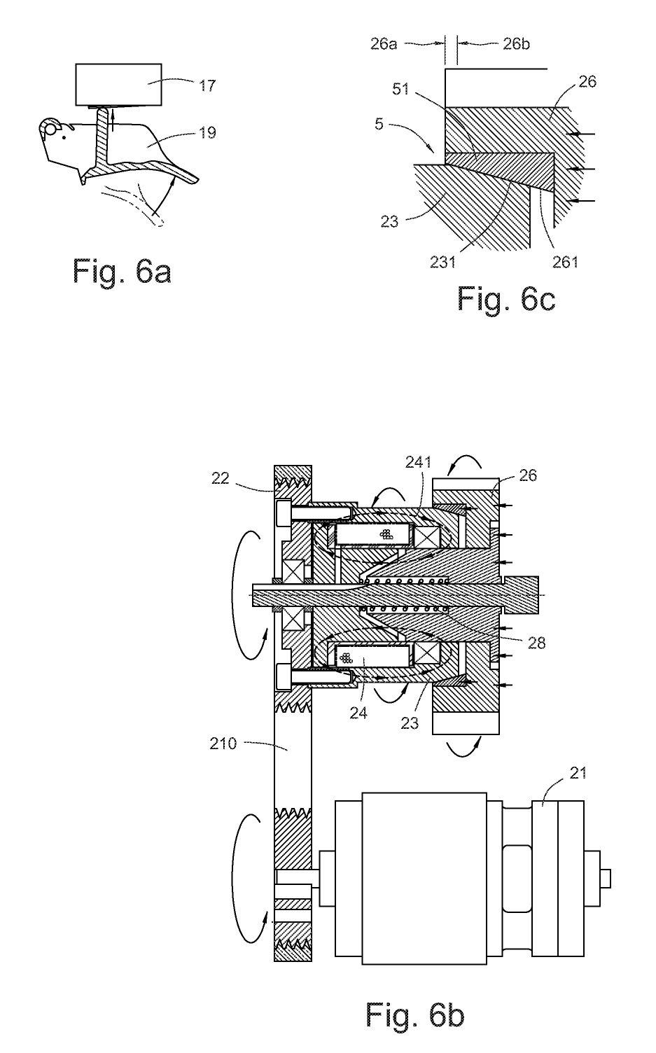

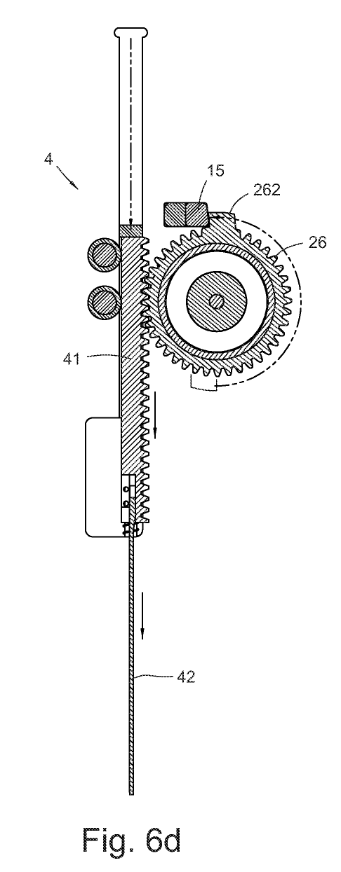

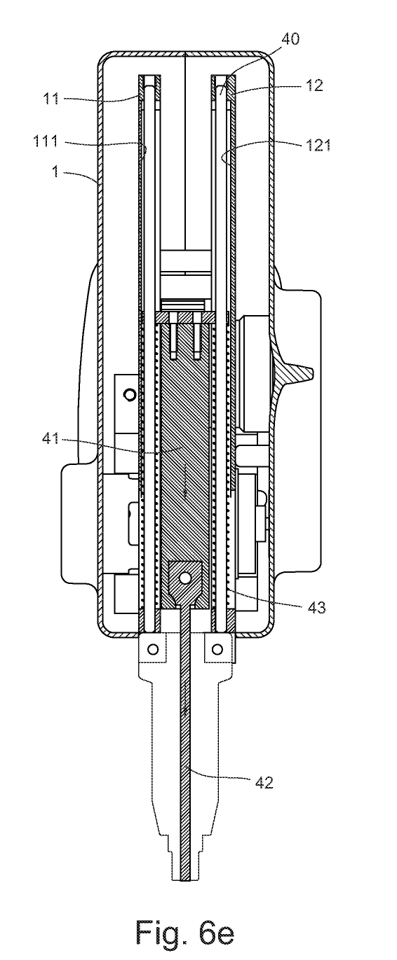

In this embodiment, the linear transmission unit 4 has a rack 41 mounted by a spring in the nail gun 1 in mesh with the driving wheel 26. A hitting bar 42 is formed on the rack 41 so that the hitting bar 42 can hit a nail when the rotary kinetic energy of the driving wheel 26 is transformed into the linear kinetic energy of the rack 41 (shown in FIG. 6d and FIG. 6e).

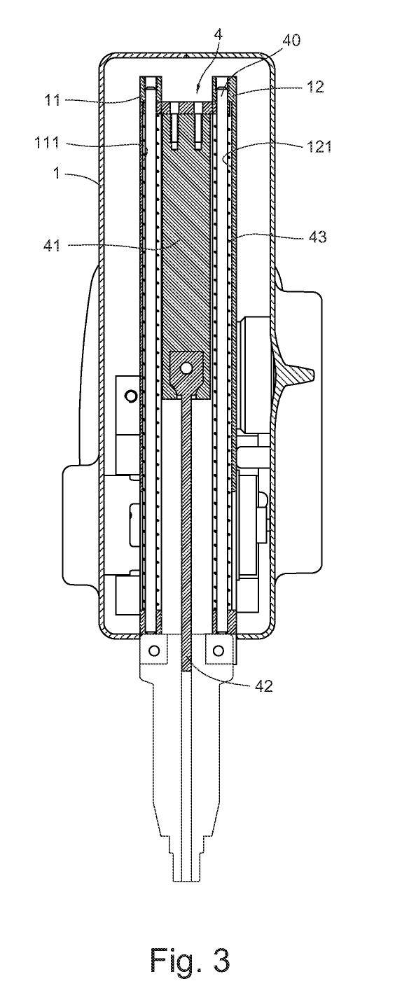

More specifically, at least a guiding bar 40 is disposed at a side of the driving wheel 26. In this embodiment, two guiding bars 40 are respectively and vertically disposed in a vertical guiding grooves 111 and 121 of a supporting brackets 11, 12 respectively beside the driving wheel 26. The rack 41 is slidably disposed between the two guiding bars 40 to receive the driving of the driving wheel 26. A first elastic member 43 is disposed on the guiding bar 40. The pushing force exerted by the first elastic member 43 is smaller than the force exerted by the driving wheel 26 in rotation and is configured to push the rack 41 to drive the hitting bar 42 to move upward and reset (shown in FIG. 3). The first elastic member 43 can be a compression spring.

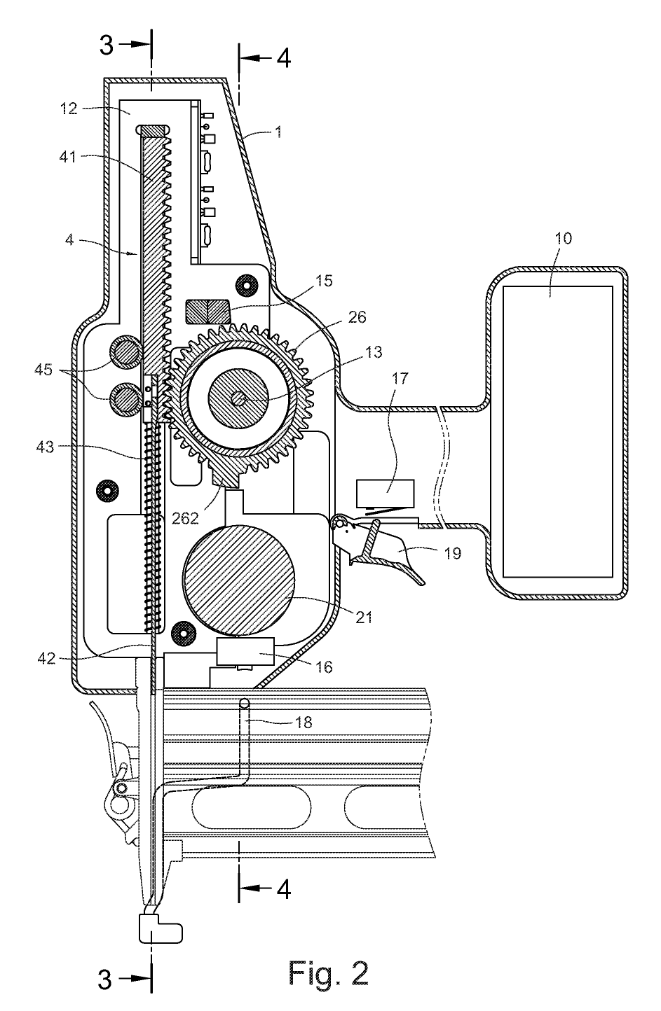

A slide base 44 is disposed on a top of the rack 41. Both sides of the slide base 44 are respectively disposed in the two guiding grooves 111 and 121 (shown in FIG. 1 to FIG. 3). Two curved grooves 441 are respectively disposed on each of the two sides of the slide base 44 to hold the two guiding bars 40 so that the guiding bars 40 can receive the first elastic member 43. The rack 41 is guided to be disposed between the two guiding bars 40. At least a turning wheel 45 is pivotably disposed near to the driving wheel 26. In this embodiment, there are two turning wheels 45. The rack 41 is in mesh with the driving wheel 26 and can be driven through between the driving wheel 26 and the turning wheels 45.

The rotary transmission unit 2 includes a motor 21, a flywheel 22, a solenoid 24, and a driving wheel 26.

The motor 21, which is securely mounted on bottom ends of the supporting bracket 11, 12 can be driven by the battery pack 10 controlled via the first switch 16 or the second switch 17. Alternatively, the motor 21 may be driven by other AC (alternating current) power supplies via a conductive wire. A drive belt wheel 210 is disposed on an axis of the motor 21.

The configuration of the flywheel 22 is similar to the configuration of the belt wheel 210. The flywheel 22 is pivotably mounted on a stop shaft 13, which is fixedly mounted between a supporting arm 14 and the supporting bracket 12 to cause the flywheel 22 to locate above the motor 21. The supporting bracket 11 extends outwards to form the supporting arm 14 thereon. A belt 211 is wrapped around the drive belt wheel 210 and the flywheel 22 to cause rotation of the flywheel 22. In addition, an end side of the flywheel 22 extends outwards to form a cylinder 23, to thereby rotate together with the flywheel 22. Alternatively, the cylinder 23 may be fixedly attached to the flywheel 22. The cylinder 23 should be made of magnetic material regardless of attachment of the cylinder 23 to the flywheel 22. A ring-shaped receiving chamber 230 is defined in the cylinder 23.

The solenoid 24, which is buried in the receiving chamber 230 of the cylinder 23, does not rotate along with the flywheel 22 and the cylinder 23. In the first embodiment of the present invention, the solenoid 24 is wrapped around an insulative ring stand 240 and may be activated by current that is controlled by the first switch 16 or the second switch 17. Thus, a magnetic loop 241, as shown in FIG. 6b, is formed around the solenoid 23 when the solenoid 24 is activated, so that a magnetic field is produced. In greater detail, a ring-shaped bearing 25, made of magnetic material, is securely mounted on the stop shaft 13, and the ring stand 240 is fixedly attached to an outside wall of the bearing 25 to cause the ring stand 240 to be securely disposed on the stop shaft 13 via the bearing 25.

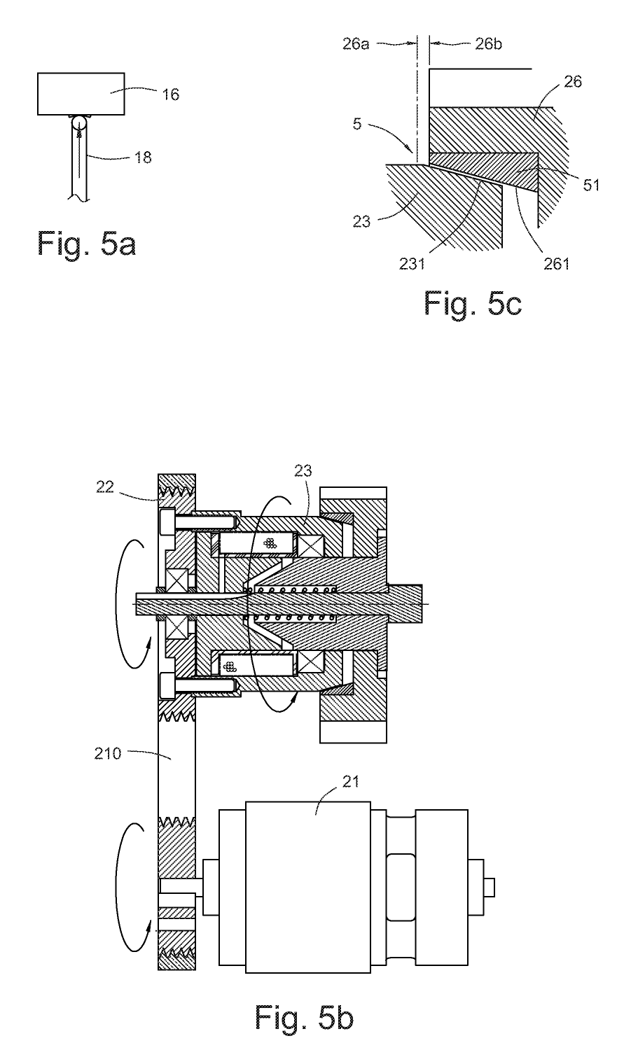

The driving wheel 26, adjacent to an end side of the cylinder 23, is pivotably disposed between an engagement position 26a (shown in FIG. 6c) and a disengagement position 26b (shown in FIG. 5c). More specifically, the driving wheel 26 is fixedly disposed on a ring-shaped traction stand 27 made of magnetic material. The traction stand 27 is moveably and pivotably mounted on the stop shaft 13. An end of the traction stand 27 is formed to have at least a protruding block 271 which is used to push the driving wheel 26 to move towards the cylinder 23. Further, two opposite slantwise friction surfaces 231, 261 are respectively formed on the cylinder 23 and the driving wheel 26 to be used as a clutch 5. In greater detail, the clutch 5 includes a plurality of slantwise linings 51 fixedly mounted on the driving wheel 26. One of side walls of the slantwise linings 51, adjacent to the end surface 231 of the cylinder 23, may be regarded as an end surface 261. Thus, the slantwise linings 51, the cylinder 23, and the driving wheel 26 cooperatively constitute a clutch 5 which can be engaged or disengaged.

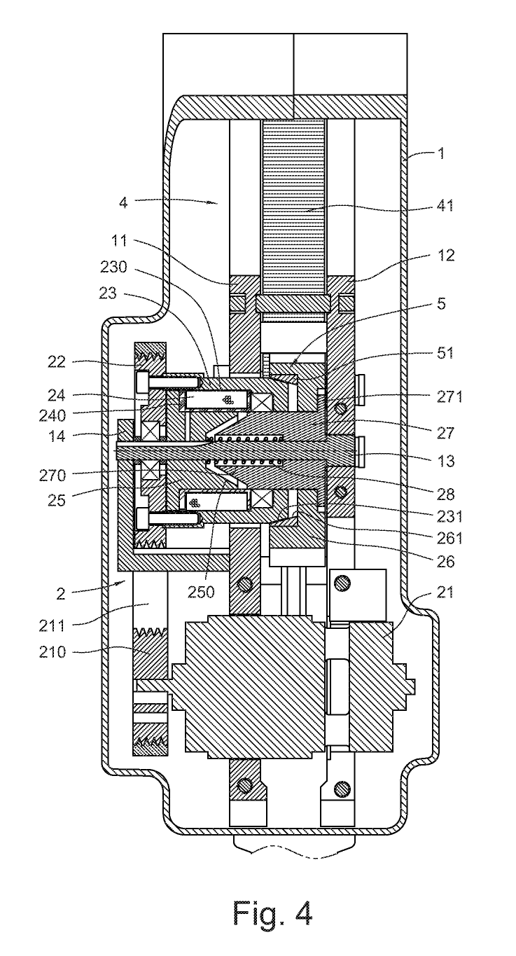

In addition, the present invention also includes a second elastic member 28 configured for exerting an pushing force on the driving wheel 26, thereby pushing the driving wheel 26 from the engagement position 26a (shown in FIG. 6c) to the disengagement position 26b (shown in FIG. 5c). Generally, the pushing force should be less than an applied force with which the magnetic field attracts the driving wheel 26 to move. In the first embodiment, as shown in FIG. 1 to FIG. 4, the second elastic member 28 may be a compressing spring which is received between a tapered slot 250 defined in the bearing 25 and a receiving slot defined in the traction stand 27.

Furthermore, a stop block 262 is extended from the driving wheel 26, and a brake post 15 is transversely disposed between the two supporting brackets 11, 12. When the rotary kinetic energy of the flywheel 22 is transformed to the driving wheel 26 via the cylinder 23 and the clutch 5, the brake post 15 can limit an angle by which the driving wheel 26 rotates, and thereby control a linear displacement of the rack 41.

According to the above-mentioned configuration, when using the electric nail gun to nail a workpiece, a user must first push the safe sliding rod 18 against the workpiece to turn on the first switch 16 (shown in FIG. 5a), which causes the motor 21 to rotate, thereby driving the flywheel 22 and the cylinder 23 to rotate via the belt 211 (shown in FIG. 5b). Subsequently, the user pulls the trigger 19 to switch on the second switch 17 (shown in FIG. 6a). Thus, the current from the battery pack 10 flows towards the solenoid 24 to cause the solenoid 24 to be activated. Therefore, the magnetic conductivity loop 241, as shown in FIG. 6b, is constructed around the solenoid 23 when the solenoid 24 is activated. The magnetic field is thus produced to attract the driving wheel 26 to push against the elastic member 28, thereby urging the driving wheel 26 to move from the disengagement position 26b to the engagement position 26a. The rotary kinetic energy of the flywheel 22 and the cylinder 23 is immediately passed on to the driving wheel 26 to urge the driving wheel 26 to rotate, thereby downwardly moving the rack 41 (shown in FIG. 6d). The rotary kinetic energy of the flywheel 22 and the cylinder 23 is transformed into the linear kinetic energy of the hitting bar 42 until the stop block 262 of the driving wheel 26 is stopped by the brake post 15. Meanwhile, the first and second switches 16 and 17 are automatically switched off so that the motor 21 stops rotating, the solenoid 24 is off, and the magnetic conductivity loop 241 is demagnetized to cause the magnetic field to vanish. Accordingly, the driving wheel 26 is pushed to the disengagement position 26b due to recovery of the elastic member 28, thereby disengaging from the flywheel 22. As such, the rack 41 stops moving downwards and then the rack 41 returns the original position due to recovery of a first elastic member 43 in the linear transmission unit 4. A single sequential actuation is thus finished as the user releases the safe sliding rod 18 and the trigger 19.

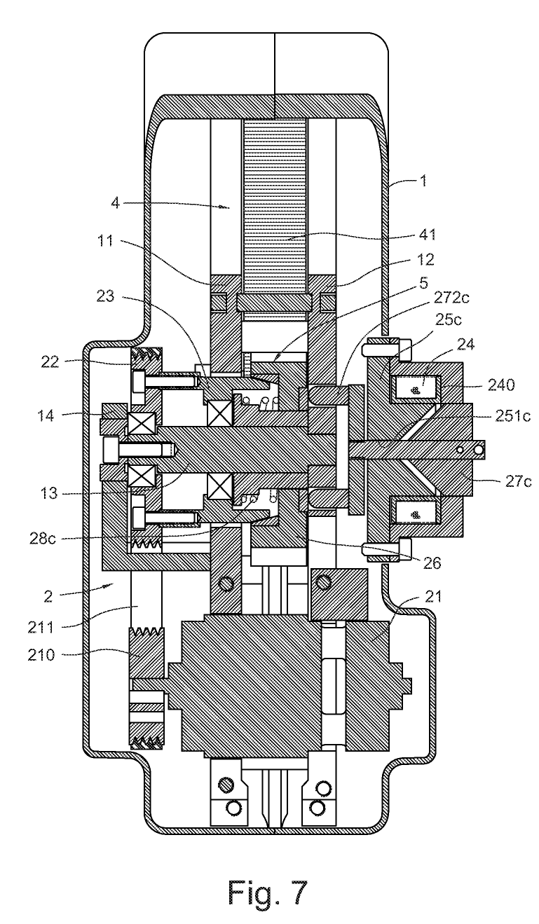

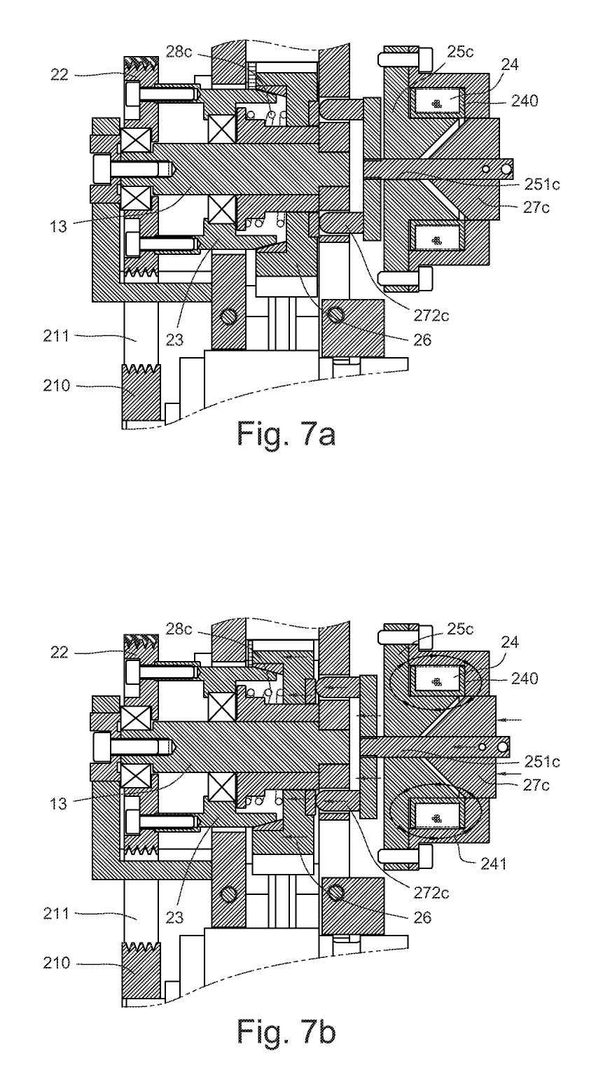

Referring to FIG. 7, a transmission mechanism in accordance with a second embodiment of the present invention differs from the first embodiment in that a ring-shaped bearing 25c is disposed close to a side of the stop shaft 13. The ring-shaped bearing 25c has a center through hole 251c. The ring stand 240 is fixed on an outer wall of the ring-shaped bearing 25c. The solenoid 24 is fixed on an outer wall of the ring-shaped bearing 25c by the ring stand 240. The ring-shaped bearing 25c is made of magnetic material so that a magnetic loop 241 can be formed thereon when the solenoid 24 is active (referring to FIG. 7). An attracting magnetic field can hence be formed on the magnetic loop 241. The traction stand 27c is disposed on a side of the ring-shaped bearing 25c and made of magnetic material. The traction stand 27c has a push paw 272c which extends through the through hole 251c and is capable of pushing or releasing the driving wheel 26. The second elastic member 28c is disposed in the cylinder 23 between the flywheel 22 and the driving wheel 26. The pushing force of the second elastic member 28c is less than the force with which the traction stand 27c attracted by the magnetic field drives the push paw 272c to push the driving wheel 26 to move. The rest of this embodiment is identical or equivalent to the first embodiment. Accordingly, when magnetically activated by the solenoid 24, the traction stand 27c is attracted by the magnetic field, moves toward the cylinder 23, and further drives the push paw 272c to push the driving wheel 26 to move in a geared position 26a (referring to FIG. 6c and FIG. 7b). The driving wheel 26 is driven by the kinetic energy of the flywheel 22 (referring to FIG. 6d) to drive the rack 41 to further drive the hitting bar 42 to move linearly downward and hit a nail. The traction stand 27c is released when the solenoid 24 is demagnetized which further releases the driving wheel 26 so that the driving wheel 26 can receive pushing from the second elastic member 28c and move to a disengagement position 26b (referring to FIG. 5c) so as to be disengaged from the kinetic energy of the flywheel 22 and stop driving the rack 41. The rest operation of the this embodiment is identical or equivalent to the first embodiment.

To sum up, the present invention has sufficiently taught necessary technical features which can be employed in industry. It is a novelty for employing magnetic field effect of the solenoid to control engagement or disengagement of the driving wheel in/from the flywheel so as to transmit rotary kinetic energy to drive the rack to move the hitting bar downward to hit a nail. A reasonable configuration for the flywheel, the solenoid, the clutch, and the driving wheel is space saving. The durability of the transmission mechanism for the electric nail gun is also improved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A transmission mechanism for an electric nail gun comprising:
a linear transmission unit in a housing of the electric nail gun; and
a rotary transmission unit in the housing comprising an electric driven driving wheel, wherein the linear transmission unit comprises a rack and a hitting bar, the hitting bar being disposed at a bottom of the linear transmission unit, the rack being in mesh with the driving wheel, slidably installed in the housing by a spring force, and configured to receive driving from the driving wheel and to drive the hitting bar to move linearly downward so as to hit a nail.

2. The transmission mechanism as described in claim 1, wherein at least a guiding bar is vertically disposed on a side of the driving wheel, the rack is slidably installed on the guiding bar, and a first elastic member is disposed on the guiding bar and configured for pushing the rack to drive the hitting bar to move upward and reset when the driving wheel stops rotating.

3. The transmission mechanism as described in claim 2, wherein a slide base is disposed on a top of the rack holding the guiding bars and configured for guiding the rack to be slidably installed on the guiding bars.

4. The transmission mechanism as described in claim 1, wherein at least a turning wheel is pivotably disposed near to the driving wheel, and the rack is disposed between the driving wheel and the turning wheel and is in mesh with the driving wheel.

5. The transmission mechanism as described in claim 1, wherein the rotary transmission unit further comprises:
a motor that can be driven by electricity;
a flywheel driven by the motor, the flywheel pivotably mounted on a stop shaft and having a cylinder extending from a side of the flywheel, the cylinder being made of magnetic material and defining a ring-shaped receiving chamber therein; and
a solenoid that can be activated by electricity being buried in the receiving chamber and configured for forming magnetic field around a magnetic loop on the cylinder, wherein the driving wheel is movably and pivotably disposed between an engagement position near to an end of the cylinder and a disengagement position, and at least two friction surfaces are respectively disposed near to the driving wheel and the cylinder therebetween, the friction surfaces being capable of working as a clutch,
wherein the driving wheel is configured to be attracted to move to the engagement position to be driven by the flywheel, and thereby to drive the linear transmission unit to hit a nail when the solenoid is activated by electricity, and configured to be reset to the disengagement position to disengage from the flywheel, and thereby to stop driving the linear transmission unit when the solenoid is demagnetized.

6. The transmission mechanism as described in claim 5, further comprising a second elastic member configured for exerting an pushing force on the driving wheel, and thereby pushing the driving wheel from the engagement position to the disengagement position, the pushing force being configured less than the force exerted by the magnetic field to attract the driving wheel to move.

7. The transmission mechanism as described in claim 6, wherein the second elastic member is disposed between the ring-shaped bearing securely mounted on the stop shaft and a ring-shaped traction stand moveably and pivotably attached to the stop shaft.

8. The transmission mechanism as described in claim 1, wherein the rotary transmission unit further comprises:
a motor that can be driven by electricity;
a flywheel driven by the motor, the flywheel pivotably mounted on a stop shaft and having a cylinder extending from a side of the flywheel,
a ring-shaped bearing made of magnetic material being disposed near to an end of the stop shaft, the ring-shaped bearing having a through hole;
a solenoid that can be activated by electricity buried in the receiving chamber and configured for forming magnetic field around a magnetic loop on the cylinder, wherein the driving wheel is movably and pivotably disposed between an engagement position near to an end of the cylinder and a disengagement position, and at least two friction surfaces are respectively disposed near to the driving wheel and the cylinder therebetween, the friction surfaces being capable of working as a clutch; and
a traction stand made of magnetic material disposed at an end of the ring-shaped bearing, the traction stand having a through hole and a push paw configured for pushing or releasing the driving wheel, wherein the traction stand is configured to be attracted by the magnetic field created by the solenoid to drive the push paw to push the driving wheel to the engagement position to be driven to rotate by the flywheel, and thereby to drive the linear transmission unit to hit a nail when the solenoid is activated by electricity, and is configured to be released to release the driving wheel to a disengagement position to be disengaged from the kinetic energy of the flywheel and to stop driving the rack when the solenoid is demagnetized.

9. The transmission mechanism as described in claim 8, further comprising a second elastic member configured for exerting an pushing force on the driving wheel, and thereby pushing the driving wheel from the engagement position to the disengagement position, the pushing force being configured less than the force with which the traction stand attracted by the magnetic field drives the push paw to push the driving wheel to move.

10. The transmission mechanism as described in claim 9, wherein the second elastic member is disposed in the cylinder between the flywheel and the driving wheel.
